(19) United States
(12) Patent Application Publication
(10) Pub. No.: US 2024/0194398 A1
(43) Pub. Date: Jun. 13, 2024

(54) Inductive Component with Annular Cores and SMD Connections

(71) Applicant: Vacuumschmelze GmbH & Co. KG, Hanau (DE)

(72) Inventors: Harald Hundt, Hanau (DE); Axel Schulze, Hanau (DE)

(21) Appl. No.: 18/286,893

(22) PCT Filed: Apr. 14, 2022
(86) PCT No.: PCT/EP2022/060060

§ 371 Date: Oct. 13, 2023

(30) Foreign Application Priority Data
Apr. 16, 2021 (DE) 10 2021 109 649.9

(51) Int. Cl. H01F 27/30; H01F 27/24; H01F 27/28; H01F 27/29

(52) U.S. Cl. CPC H01F 27/306; H01F 27/24; H01F 27/2823; H01F 27/29

(57) ABSTRACT

The invention relates to an inductive component. According to one embodiment, the component comprises an annular magnetic core, at least two windings which are wound about the magnetic core, and multiple contact feet. The contact feet have openings for inserting wire ends of the windings and a respective contact surface for surface mounting the inductive component. The contact surfaces lie in a connection surface with a defined degree of evenness, wherein openings in the contact feet are arranged at a distance from the connection surface and are designed such that the position and angular deviations of the wire ends with respect to the connection surface can be compensated for by the respective contact foot. Each contact foot is bonded to the wire end (20) inserted into the opening of the respective contact foot.

### TECHNICAL AREA

The present disclosure relates to the field of inductive components that are suitable for surface-mounting (surface-mounted devices, SMD).

### BACKGROUND

Inductive components (transformers, chokes, etc.) with closed soft magnetic cores (ring cores) are widely used in a wide variety of applications. One or more coils of winding wire (usually copper wire) are usually wound around the soft magnetic core. The soft magnetic core may be placed in a plastic housing that protects the core from mechanical stress, dust, and moisture. Such a housing is also called a “core tray”.

Inductive components are usually mounted on a printed circuit board (PCB) using through-hole technology or surface-mounting technology. In many applications, surface-mounting is desirable or required, allowing fully automated robotic placement and reflow soldering, which provides significant cost advantages. Components suitable for surface mounting are referred to as SMD (surface-mounted devices).

With SMD components, one challenge is the flatness (coplanarity) of the SMD terminals, since all terminals must be safely immersed in the solder paste on the board before soldering. A relatively small (e.g., 100 μm maximum) deviation from a perfect flat plane is permissible for the ends of the SMD leads of an SMD component. During the reflow soldering process, the mentioned coplanarity should be maintained.

SMD components are usually comparatively small, such as resistors, diodes or integrated circuits (e.g. in a Plastic Small-Outline Package, PSOP). Since a surface mounting technique is usually less expensive than a through-hole mounting technique, users are increasingly demanding that larger components (such as inductive components) also be designed as SMD components.

For inductors with ring cores, the lead-out of the ends of the winding wire in horizontal designs (ring core parallel to the circuit board in the mounted state) can be roughly divided into three groups:

First, components with thin-wire windings (for example, with a diameter smaller than 0.5 mm) usually require separate connection pins for SMD mounting. Since the connection pins interfere during winding the wire around the ring core, it is common practice to use a separate plastic part, for example a housing or a base plate, to which the connection pins are attached. After winding, the housing or the wound ring core is mounted on the base plate, the wire is fed to the terminal pins and connected to them, for example by soldering. The connection pins usually have a larger cross-section than the wire, which enables greater strength and stability of the SMD contacts than if the end of the wire itself were designed as a “pin”.

Second, for components with windings wires of medium thickness (for example with a diameter between 0.5 mm and around 3-4 mm), only very limited solutions are currently available. Since, when connected to a common pin, the wire would bend the pin, and thus the coplanarity of the pins changes, more elaborate solutions are required. For example, a pin with two ends may be used, where the wire is soldered to the pin at one end, and the other side of the pin forms the SMD contact. Connecting a pin with a wire, for example, 2 mm thick, requires the pin to be fixed so rigidly in order to maintain the required coplanarity that this is no longer readily possible with common plastic parts.

Third, for devices with large diameter wire windings (for example, with a diameter greater than 4 mm), surface mounting is problematic because the reflow soldering process is more difficult due to the high heat capacity of the terminals, and the strip lines on the circuit boards with the required current carrying capacity are complex and expensive.

Particularly in the fields of electromobility and renewable energies, electrical components such as chokes are required for high currents. These can therefore have windings made of relatively thick wire to achieve the necessary current carrying capacity. For inductive components that are larger (in terms of their electrical power and in terms of their geometric dimension), such as chokes with a large-diameter wire winding, it can be challenging to form SMD terminals from the (relatively thick) winding wire, on the one hand, and to arrange them coplanar with comparatively small tolerances across the widely spaced terminal positions in a flat plane, on the other hand. However, as mentioned, coplanarity is important to ensure that all SMD contacts of the component are located within the solder paste layer applied to the board during the (reflow) soldering process and can be reliably soldered.

In order to manufacture an inductive component such as a choke, various materials and manufacturing processes may be used which influence the flatness (coplanarity) of the contact surfaces. For example, the employed parts and materials, which have specific mechanical properties (e.g. stiffness, elasticity, yield strength, internal stresses, etc.), can have a negative effect on the coplanarity of the contact surfaces both during the manufacture of the inductive component and in the subsequent soldering process. Furthermore, manufacturing processes such as the application of a large-diameter wire winding (winding processes for large-diameter wire windings) cause a mechanical load on the body, around which the wire is wound, as well as on the winding wire itself. These processes can also have a negative influence on the coplanarity of the SMD contact surfaces.

In most designs of inductive components offered in SMD technology, the SMD terminals are based on contact pins integrated in plastic coil bodies or housings. Here, the flatness is largely determined by the fact that the contacts (the pins) have relatively small spacing (e.g. are arranged on an area of 30×30 mm²) and at the same time have a high stiffness and a high yield strength. Furthermore, the flatness of the SMD contacts is also only slightly affected by the application of a wire winding when using thin winding wires (<0.5 mm). For inductive components with larger dimensions (footprint between 30×30 mm² and 400×400 mm² or more), which often also have thicker winding wires (wire diameter 0.5-12 mm or more), the geometrical ratios play a significant role.

Due to the larger component dimensions and the resulting relatively widely spaced SMD contact surfaces, material stiffness, material distortion and internal stresses of the material have a significantly greater effect than with smaller component sizes. For example, with widely spaced SMD connections, an intrinsic warping of a plastic package by a few angular degrees may result in a difference in height of the SMD contact areas in the order of millimeters. The situation is further worsened by the application of a winding with large-diameter wires. Due to high forces caused by the forming of the wire when winding it around the magnetic core, a significant mechanical load is exerted, which ultimately results in further deformation of the component and its SMD contact surfaces. As a result, the usual requirements for coplanarity of the SMD contact surfaces (e.g. deviations from the ideal plane of less than 100 μm) can no longer be readily achieved. The inventors have identified a need for inductive components with magnetic cores and SMD connections improved with regard to the problems described above.

### SUMMARY

An inductive component is described herein. According to one embodiment, the component comprises a ring-shaped magnetic core, and at least two windings wound around the magnetic core, as well as several contact feet. These have openings for inserting wire ends of the windings, as well as contact surfaces for surface mounting of the respective inductive components. The contact surfaces are located in a connection plane with defined flatness, whereby openings in the contact feet are spaced from the connection plane and are designed in such a way that position and angular deviations of the wire ends, in relation to the connection plane, can be compensated by the respective contact feet. Each contact foot is materially connected to the wire end inserted into the opening of the respective contact foot.

According to a further embodiment, the inductive component comprises a ring-shaped magnetic core as well as at least one winding wound around the magnetic core; the winding consisting of a winding wire with a round cross-section. The component further comprises exactly three terminal carriers with one or more terminal elements, wherein the wire ends of the winding wires are guided to the undersides of corresponding terminal elements of the terminal carriers, and wherein the undersides of the terminal elements lie in a connection plane for surface mounting.

Furthermore, a method for manufacturing an inductive component is described herein. According to one embodiment, the method comprises producing at least two windings around a magnetic core; placing contact feet, each of which has a contact surface for the surface mounting of the inductive component in such a way that the contact surfaces of the contact feet lie in a connection plane with defined flatness; and inserting the wire ends into corresponding openings in the contact feet. Thereby, the openings in the contact feet are spaced from the connection plane and are designed in such a way that position and angular deviations of the wire ends with respect to the connection plane are compensated by the respective contact feet. The method further comprises connecting the contact feet to the respective wire ends by forming a material bond.

### BRIEF DESCRIPTION OF THE ILLUSTRATIONS

Various embodiments are explained in more detail below with reference to drawings. The drawings are not necessarily to scale and the embodiments are not limited to the illustrated aspects. Rather, emphasis is placed on illustrating the principles underlying the depicted embodiments.

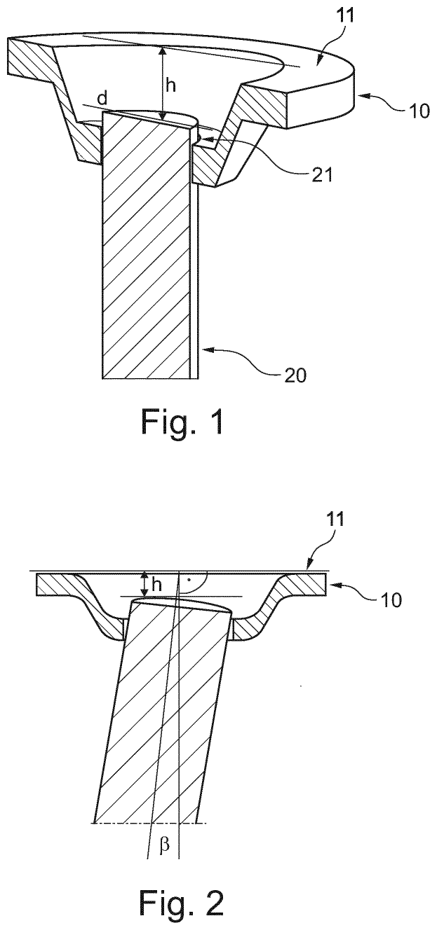

FIG. 1 illustrates an example of a wire end of a coil winding with a contact foot that has a contact surface for surface mounting (SMD contact surface).

FIG. 2 illustrates how the contact foot of FIG. 1 can compensate for position errors (angular and distance errors with respect to a nominal position) of the wire end.

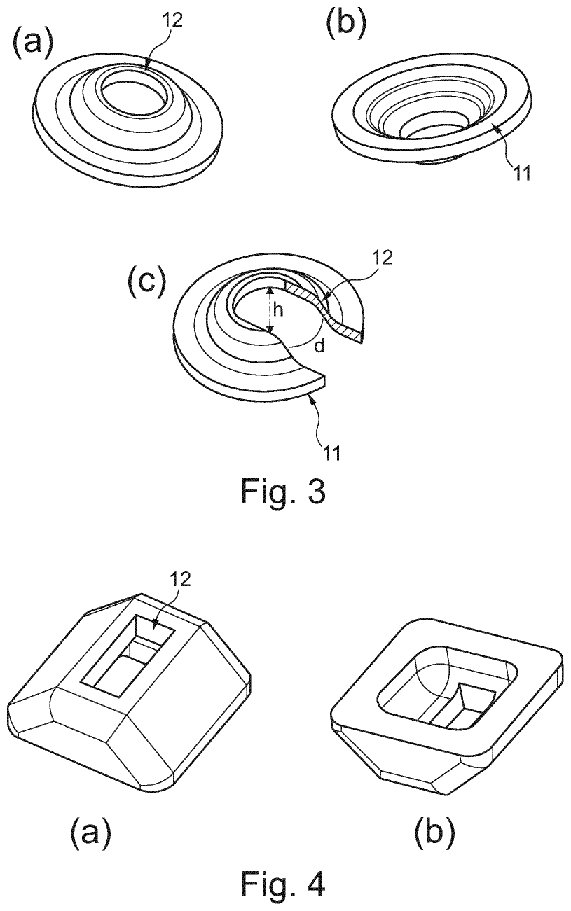

FIGS. 3 and 4 show various designs and modifications of the contact foot of FIG. 1.

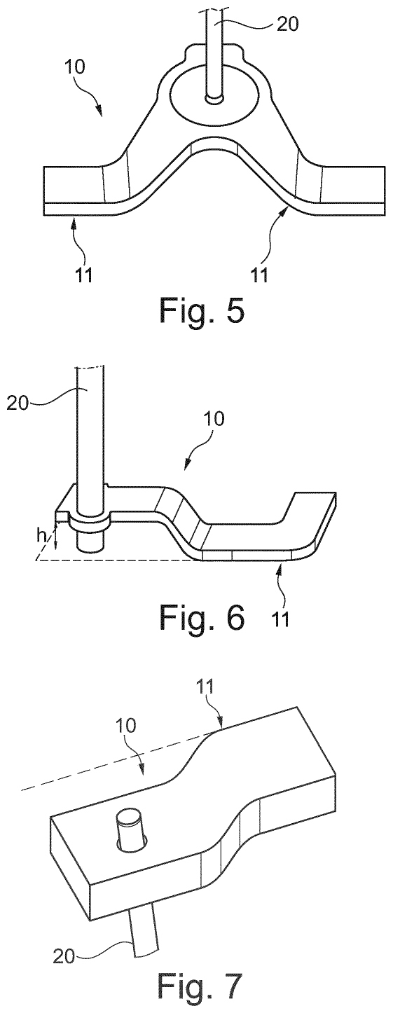

FIGS. 5 to 7 show various alternative designs of contact feet for inductive components with SMD contact surfaces.

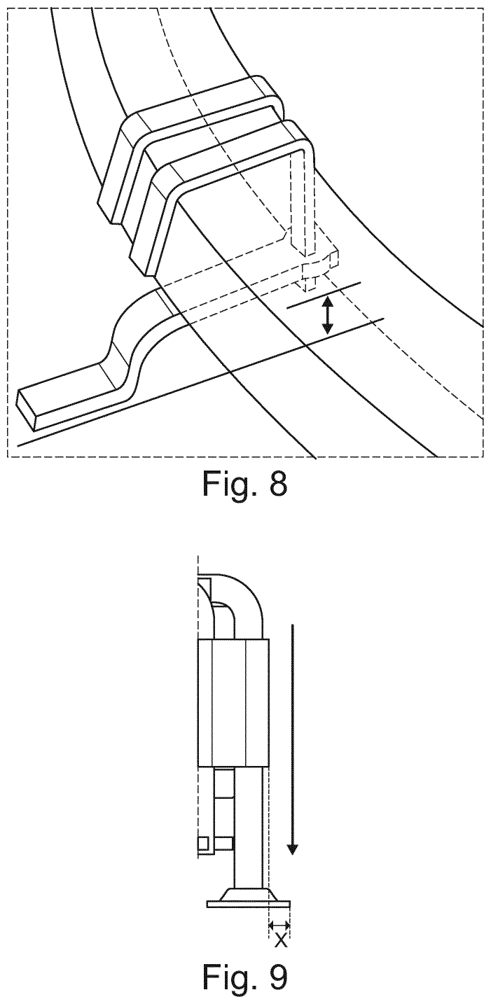

FIG. 8 shows another example of a contact foot and its connection to one end of a winding.

FIG. 9 illustrates the arrangement for an automatic optical inspection to check the correctness of the wetting situation of the SMD connections of the inductive component after the soldering process.

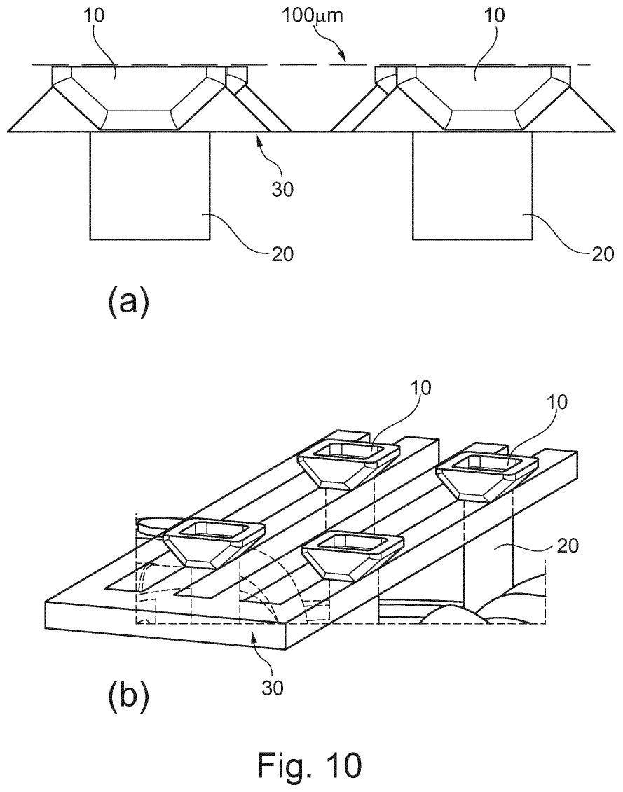

FIG. 10 illustrates a support for proper coplanar alignment of multiple contact feet prior to permanent connection (e.g., welding) of the contact feet to their respective wire ends.

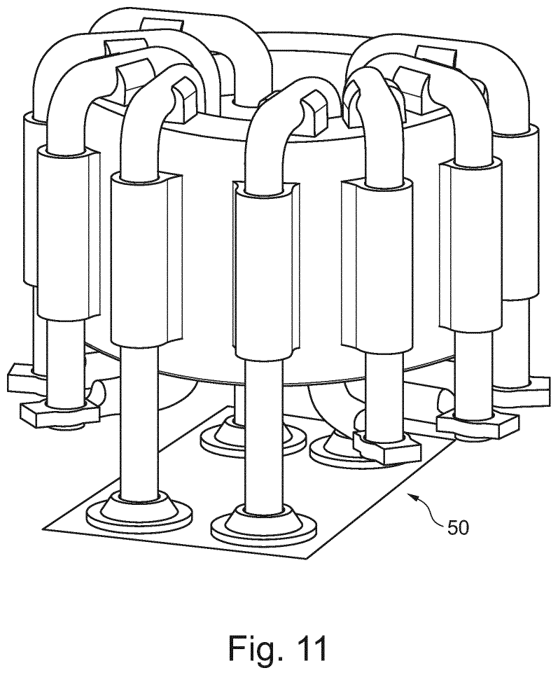

FIG. 11 illustrates the positioning of the contact feet on a reference plane before the contact feet are firmly connected (e.g. welded) to the respective wire ends to ensure coplanarity of the SMD contact surfaces of the contact feet.

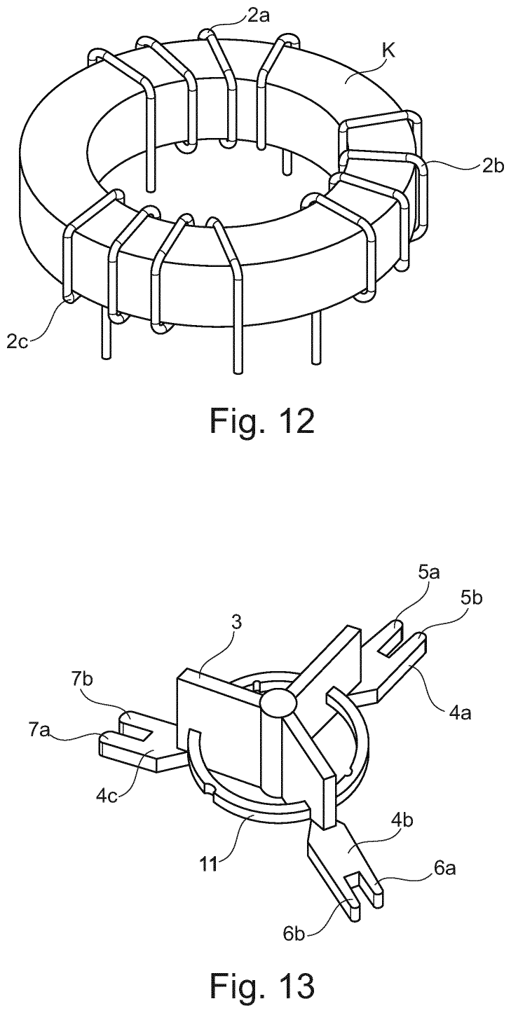

FIG. 12 illustrates a general example of an inductive component with three windings.

FIG. 13 illustrates a separator which can be placed in the inner hole of the component of FIG. 12 and which has terminal carriers with terminal elements to which the wire ends of the winding wires are guided and there form SMD contacts for surface mounting.

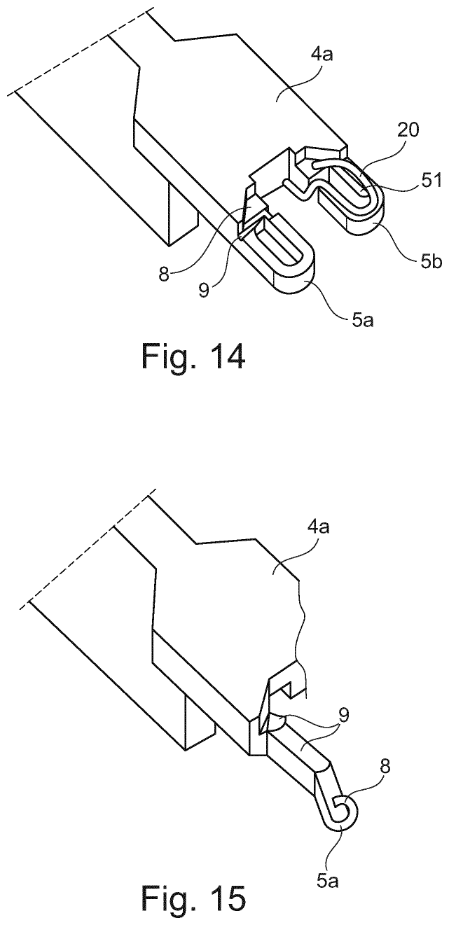

FIG. 14 illustrates a first example of the terminal elements from FIG. 13.

FIG. 15 illustrates an alternative design of the terminal elements.

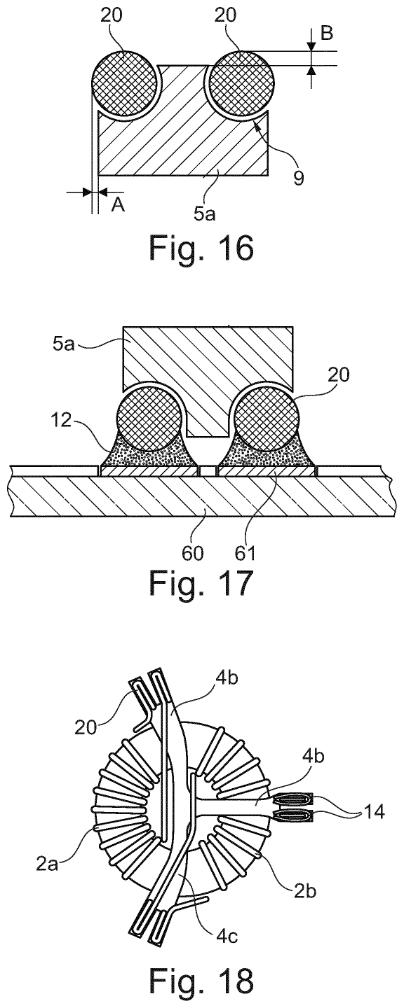

FIG. 16 shows a cross-section through a terminal element (upside down) from FIG. 13 with winding wire inserted therein.

FIG. 17 shows a cross-section of the terminal element from FIG. 16 in a soldered state mounted on a printed circuit board.

FIG. 18 shows an inductive component with two coils, where one terminal carrier is occupied by non-contacted conductor pieces (dummy wire pieces).

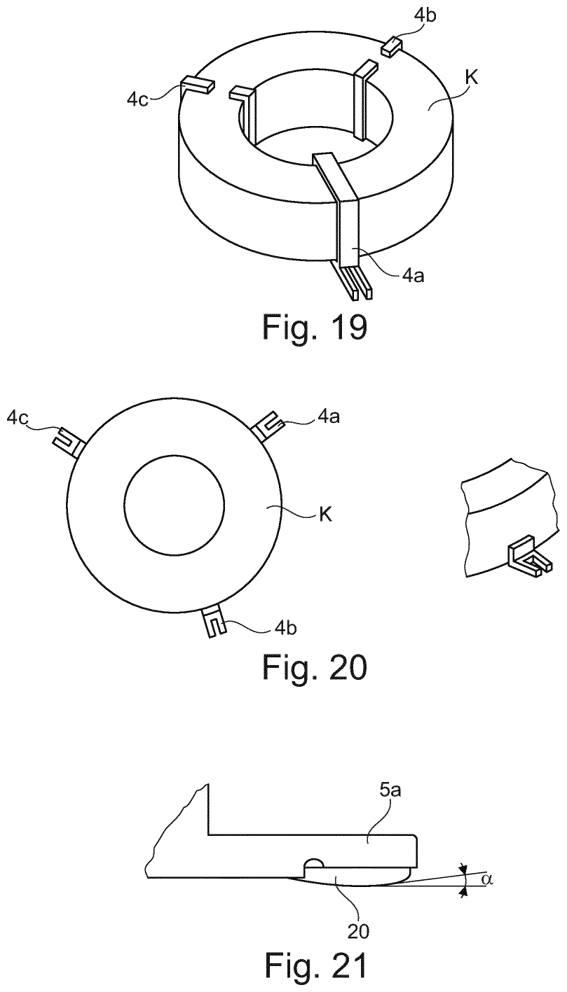

FIG. 19 shows an embodiment with terminal carriers mounted on a ring core

FIG. 20 shows an embodiment in which the ring core is arranged in a core tray and the terminal carriers are attached to the core tray.

FIG. 21 is a side view of the terminal element from FIG. 16.

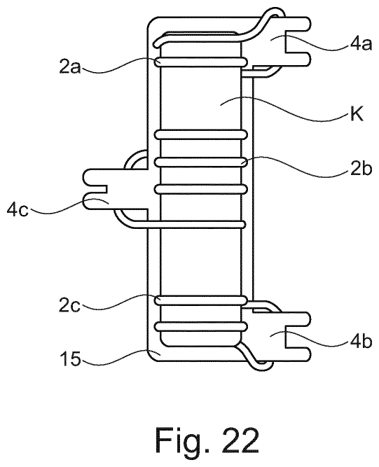

FIG. 22 illustrates a top view of an example with the ring core mounted in an upright position.

### DETAILED DESCRIPTION

Some of the embodiments described herein allow inductive devices with ring cores and large-diameter wire windings to be designed such that, almost regardless of the dimension and size of the device, a coplanar solderable SMD connection plane with a flatness/coplanarity of about 100 μm or less can be provided.

Some of the embodiments described herein allow inductive components with ring cores and windings of medium-diameter wire to be designed as SMD components and soldered to an SMD board without using a package or an intermediate carrier with terminal pins. In these embodiments, this is achieved by using the wire ends themselves as terminals.

This economical solution becomes possible in these embodiments because the problem of coplanarity (i.e. the height differences of the connections) is solved by using exactly three connection carriers (each equipped with one or more contacts). The electrical connections of the wire windings are distributed over exactly three connection carriers, regardless of the number of connections. Since several connections can be close together on one carrier, height differences between them are negligible. The three connection carriers clearly define a plane in relation to each other and therefore inevitably lie statically determined on the board. In the case where two or more electrical contacts (lying relatively close to each other) are attached to a connection carrier, the height differences between them, which may arise during manufacture, but also due to possible twisting or torsion of the carrier parts during assembly, are only small and the coplanarity requirement (e.g. less than 100 μm) can still be met. If the carrier parts, which have to be constructed of an electrically insulating material, are now made, e.g., of plastic further optimization is possible. In many applications, a separator is required for safe insulation of the windings, which is also made of plastic. If these two functions are combined, only one (single) plastic part is required, resulting in very low-cost production. The need for separators is often required for current-compensated chokes (common-mode chokes, CMC) used in higher voltage domains (e.g. with regard to leakage currents).

In the embodiments described herein, the term ring core or ring-shaped core does not necessarily mean a circular core, but merely that the core describes a closed curve, possibly with an air gap. A ring core can therefore also be oval, for example. When the inductive component is mounted horizontally, the longitudinal axis of the ting core is normal to the printed circuit board on which the component is mounted. In an upright mounting, the longitudinal axis of the ring core is parallel to the printed circuit board. In general, the term “underside” is understood to mean that side of the component which faces or touches the printed circuit board in the mounted state.

First, embodiments of inductive components with large-diameter wire windings are explained in more detail. In the approach described below, the required coplanarity of the SMD contact areas is achieved by first running through all the necessary manufacturing processes to produce an inductive component with large-diameter wire windings without producing the SMD contact areas. Only subsequently prefabricated compensation elements—referred to below as contact feet—are connected to the ends of the (thick) winding wire using a material bonding process with no (or only little) mechanical stress. These contact feet have the SMD contact surfaces.

Further mechanical manufacturing processes for reshaping and forming SMD contacts using the wire winding ends, which could negatively influence the coplanarity of the individual SMD contact surfaces, are not required. The contact feet, which are to be bonded separately to the wire ends, take on the task of compensating for specific material properties (e.g. warpage due to residual stresses, shrinkage, dimensional stability, etc.) as well as absorbing and neutralizing wire length differences and/or angle differences caused by the previous manufacturing processes. At the same time, further negative mechanical influences for the realization of SMD contact areas are avoided by using a material-bonding joining process such as soldering or welding. The contact feet with SMD contact areas thus serve to decouple any misalignments of the winding wire ends of the inductive component from the SMD connection plane in which the SMD contact areas of the contact feet are to be located.

In order to provide an inductive component with a large-diameter wire winding, the turns of a winding can be applied, for example, by means of a manual winding process or an automated process. For this purpose, individual pieces of wire of wire windings or prefabricated individual pieces of wire such as brackets can be joined together to produce complete turns of a winding. Wire dimensions for components with a large-diameter wire winding can typically range from 0.5 mm to 20 mm in diameter, and bare, galvanically treated, as well as enameled wires are also used. In practice, the windings produced in this way or by another method always have winding ends (ends of the winding wire) that deviate from each other in length and angle to such an extent that the ends of the large-diameter wire themselves cannot be used as SMD contact pads. To compensate for these deviations, the aforementioned contact feet are used.

FIG. 1 schematically shows an example of a contact foot 10 into which the end of a (thick) winding wire 20 is inserted. In the depicted example, the contact foot has approximately the shape of a truncated cone, the smaller top surface of which has an opening through which the wire end 20 can be inserted into the interior of the truncated cone. On the side of the truncated cone opposite the opening, the truncated cone may have a circumferential ridge (collar) to enlarge the base area 11, which also forms the SMD contact area. The interior of the truncated cone is large enough to compensate for any length or angular deviations (with respect to the desired SMD contact area) of the wire end 20. In the present example, the contact foot 10 must compensate for a length deviation h. At the point where the wire end 20 is inserted into the opening in the contact foot 10 (connection point 21), the contact foot 10 can be bonded to the wire end 20 (e.g. by means of soldering or welding).

The minimum inner diameter d of the truncated cone is larger than the diameter of the wire end 20 in order to be able to compensate for angular deviations β without having to bend the wire end. This situation is shown in FIG. 2.

In order to be able to connect the end 20 of the winding wire to the contact foot 10, the opening in the contact foot has a certain contour which corresponds to the contour of the cross-section of the wire end 20. In the example shown in FIGS. 1 and 2, this contour is circular. However, other shaped contours such as square or rectangular are also possible. Furthermore, the contour can also be designed in such a way that several different wire ends can be inserted into a contact foot. A contact foot can also have several openings (each with the same or different contours) for several wire ends.

The contact foot has a contour or opening 12 on the face side (cover surface at the narrower end of the truncated cone) and optionally laterally/radially to accommodate wire winding ends. Various embodiments are shown in diagrams (a), (b) and (c) of FIG. 3. The opening 12 allows axial or radial insertion of the wire ends 20 into the respective contact feet. Diagram (a) and diagram (b) show the same part from different perspectives. Diagram (c) of FIG. 3 shows a similar contact foot to diagram (a) but with a side opening 12. In diagram (b), the aforementioned ridge/collar can be seen at the end of the contact foot opposite the opening. This ridge/collar forms the SMD contact area 11. The contact areas 11 of different contact feet are, with high accuracy, coplanar to an SMD mounting plane (e.g. defined by the surface of a printed circuit board). FIG. 4, diagrams (a) and (b), show another embodiment example from two different perspectives (from top and from below). In this example, the contact foot does not have a truncated cone shape, but has trapezoidal side surfaces, similar to a truncated pyramid or a double wedge. An opening with a rectangular contour is provided at the narrower end to allow insertion of a winding wire with a corresponding rectangular cross-section.

The contact feet and their SMD connection surfaces can have different shapes and can be modified/optimized with regard to the application, costs and manufacturing technology. FIGS. 5-7 show various other designs of contact feet. In addition to the simple geometric shapes in FIGS. 3 and 4, contact feet with three legs (see FIG. 5), in an S-shape (see FIG. 6) or any other shape (see FIG. 7) are also possible. The shape of the contact surface can be single or multi-part and can have almost any (flat) shape. Common to all examples is an opening for inserting the wire end 20 and the possibility of compensating for length and angle deviations of the wire ends 20 relative to the desired plane of the SMD contact surfaces. Another embodiment of the contact foot 10, which at the same time represents a part of a turn of the winding is shown in FIG. 8. Also in this case the opening, into which the wire end 20 of the winding wire is inserted, is located above the plane in which the SMD contact area 11 is located, in order to allow length and/or angle compensation.

In many applications, it is required that the contact foot 10 or at least a part thereof protrudes beyond the outer contour of the entire inductive component in order to ensure that, especially after the soldering process, the contact feet are visible and are not covered by the inductive component. This facilitates the optical detection or verification of the correct soldering of the component on the board with an AOI (Automatic Optical Inspection) system after the soldering process.

The example in FIG. 9 shows a situation in which an AOI system “looks” at a right angle onto the board to be assembled. In the example shown, the contact foot protrudes a distance x beyond the outer contour of the inductive component, which is why the correct soldering of the component and the contact surfaces can be easily detected with an AOL. However, there are also AOIs that can look at the board at a certain angle (oblique).

In the examples described herein, electrically and thermally conductive copper-based alloys are used for the manufacture of the contact feet 10, whereby various industrial processes can be used for production. Depending on the circumstances with regard to shaping, technical properties and economic aspects, stamping, embossing and bending processes, but also abrasive machining processes, can be used for this purpose. In addition, for example for small quantities or for complex geometries, production by means of additive manufacturing processes (3D printing) is possible. To ensure reliable soldering to a printed circuit board, the contact feet can also be selectively or completely nickel-plated and or tin-plated.

In principle, a corresponding number of contact feet 10 are mounted on the respective winding ends 20. To ensure the coplanarity of the SMD contact surfaces (cf. FIG. 1, contact surface 11)—before fixing the contact feet 10 to the wire ends 20—the contact feet 10 are inserted into a carrier 30, which ensures the coplanar alignment of the SMD contact surfaces of the contact feet. The carrier can have the structure of a “comb”, whereby the parallel webs of the carrier 30 (the comb) can be shaped in such a way that the contact feet come to rest in a defined position (in particular with coplanar SMD contact surfaces) between two webs. This situation is shown in FIG. 10, where diagram (a) of FIG. 10 is a side view and diagram (b) is a perspective view. The contact feet can be fixed to the carrier by various means (e.g., clamped) before, in a further step, the wire ends 20 and the associated contact feet are joined to each other by material bonding, i.e., by means of soldering or welding. Subsequently, the carrier 30 is removed. The carrier 30 is not part of the inductive component and is only required during the manufacturing process.

According to FIG. 10, when the inductive component is manufactured, the winding ends 20 of the component are aligned vertically upwards, and the contact feet 10 are plugged onto the wire ends 20 from above. As mentioned, the carrier 30/comb is used to align the contact feet 10 together, which ensures the coplanar alignment of the SMD contact surfaces of the contact feet. Subsequently, the contact feet are connected to the winding ends in this position, for example by means of soldering or welding. The interior of the contact feet 10 can be partially filled with solder from above.

An alternative method of manufacture is shown in FIG. 11, in which the winding ends of the component are oriented in reverse—downwards—and are inserted into the contact feet 10 from above, while the latter stand on a (reference) plane 50 which meets the specified flatness requirement. The reference plane has the task of positioning the contact feet coplanar with each other by gravity alone, or by means of further auxiliary devices. Subsequently, the contact feet 10 are materially bonded to the wire ends. In this example, laser welding is a viable option.

The task of ensuring the coplanarity of the SMD contact surfaces (within relatively narrow tolerances) can also be solved by ensuring that the inductive component always rests exactly with three points (i.e. small areas) on the board, because a support at three points is statically determined and the requirement of coplanarity is automatically fulfilled. FIG. 12 illustrates an inductive component with a magnetic ring core K and three coils 2a, 2b and 2c (windings) wound around the magnetic core K to form a three-phase common-mode choke (CMC, current-compensated choke). In this example, the three coils 2a, 2b and 2c have the same number of turns and are arranged in three substantially equal sectors of the ring core K. Such CMCs with three coils are known per se.

FIG. 13 illustrates a three-part separator web 3 for a three-phase CMC. In the depicted example, the separator web comprises three parts, each offset by 120° and connected at a central point. Three terminal carriers 4a, 4b, 4c may be integrated at the ends of the individual webs. The terminal carriers each comprise two terminal elements 5a, 5b, 6a, 6b and 7a, 7b, which are shown only schematically in FIG. 13, i.e. not in detail. These terminal elements have elongated carriers which contain grooves on both sides, each of which can receive one wire end of a winding wire of one of the coils. In the present example, the inductive component has three coils 2a-c (see FIG. 12), and consequently there are six wire ends (two per coil) which can be assigned to the six terminal elements 5a, 5b, 6a, 6b and 7a, 7b.

The fact that the wires protrude sideward and downwards beyond the carrier enables the following functions: (1) The solder joint of the wire ends with the board lies open, i.e. it is visible from above, and can therefore be checked with an AOI with regard to the solder quality. (2) The wire protrudes at the bottom, thus automatically forming the lowest point on all carriers, and is necessarily immersed in the solder paste when a board is assembled. Thus, electrical contact is ensured and soldering takes place without plastic parts coming into contact with the solder or the board.

The separator web 3 with the integrated terminal carriers 4a, 4b, 4c can be inserted from below into the already wound ring core (see FIG. 12) and the wire ends then bent into position and inserted into the terminal elements 5a, 5b, 6a, 6b and 7a, 7b. In FIG. 14, an example of the terminal carrier 4a is shown in a view from below (i.e., one sees the side that is in contact with the board after assembly). The terminal carriers 4b and 4c can be of identical design. A wire end 20 of a winding (e.g. winding 2a) is inserted into the terminal element 5b of the carrier 4a, and no wire is (yet) inserted into the terminal element 5a. The guidance of the wire end 20 in the semicircular grooves 9 allows precise insertion, so that the position and height of the wire ends 20 is defined. The wire ends 20 are guided in a U-shape around a web 51 at each terminal element 5a, 5b and back to a clamping surface 8, to which the wire end can be fixed by means of clamps. This prevents the wire ends from jumping out during handling and transport of the component until the time of soldering. The U-shaped guidance of the wire around the web 51 causes an increase (doubling) of the contact area with the board during soldering.

The arrangement of the connections in a CMC with three windings 2a-c requires six contact points. In order to maintain the clearances for air and creepage distances, the wires from which the coils are formed and the terminals (wire ends) of different windings must be safely insulated from each other. This is ensured by the three-part separator web 3 in the inner area of the ring core K. In order to be able to maintain the necessary distances between different voltage domains, the two terminals/wire ends 20 of a coil (e.g. coil 2a) are guided to the terminal elements of one terminal carrier (e.g. the terminal elements 5a and 5b of the connection carrier 4a). For this purpose, that wire end of the winding 2a that ends in the central opening of the ring core K must be led to the same terminal carrier 4a, on which the other wire end is also located (cf. FIGS. 13 and 14, the terminal carrier 4a has two terminal elements 5a, 5b). For this purpose, the three-part separator web 3 can optionally have support and guide structures (not shown in FIG. 14).

FIG. 15 shows another embodiment of terminal carrier 4a. Like FIG. 14, FIG. 15 is a view from below. In FIG. 15, only one of the terminal elements is shown for simplicity (terminal element 5a, the terminal element 5b not shown is of mirror symmetrical design). The wire end 20 is also not depicted in FIG. 15 to facilitate better illustration of the guide grooves 9. The wire end 20 is guided along the cup-shaped groove 9 to the outer end of the connection element 5a, and fixed under a clamping surface 8. The clamping surface 8 is tilted upwards relative to the groove 9, so that, during the surface mounting, securely the wire itself and not any plastic part is in contact with the board.

FIG. 16 shows (in cross-section) a leg of a terminal element (terminal element 5b) with a wire inserted into groove 9. In this illustration, the size ratios of the wire end 20 to the terminal element 5b as well as the protrusion laterally (protrusion A) and downward (protrusion B) can be seen. In FIG. 17, the terminal element 5b from FIG. 16 is shown (again in cross-section) together with the solder joint on the board 60. After the reflow process, the solder 12 forms a substance-to-substance bond (material connection) with the wire end 20 by wetting and thus an electrically conductive connection between one end of the winding 2a and the conductor tracks 13 on the circuit board 60.

FIG. 18 is an example of a current-compensated choke (CMC) with two coils 2a and 2b in a view from below. Since with two windings there are only four wire ends for contacting, and yet the choke must rest on the board 11 with exactly three points, the third partial web of the three-part separating web 3 must be occupied by “dummy wire pieces” 14, which are not electrically contacted with one of the windings. This allows soldering without making electrical contact. The three double soldering points thus permit a mounting symmetrically with respect to the center of gravity of the choke and a fixed connection to the circuit board. The terminal carriers 4a, 4b and 4c are constructed here as in the example shown in FIG. 14. This concept can also be used for a choke with only one coil (and consequently only two winding wire ends), which requires additional dummy wire pieces.

FIG. 19 shows an example of a ring core inductor in which the terminal carriers 4a, 4b, 4c are not attached to the ring core K as part of a three-part separator web (as in FIG. 13), but as individual parts. The connection carriers 4a-c may be evenly distributed along the circumference of the ring core K (i.e., e.g., at a 1200 angular distance from each other). The coils arranged, for example, between the terminal carriers are not shown for clarity. The terminal carriers 4a-c can be fixed to the core K after winding, for example, by means of a suitable snap connection. The terminal carriers 4a-c can then not interfere with the winding process. The variant shown is useful, among other things, for applications in which a three-part separator is not necessary for insulation.

FIG. 20 shows an example of a further embodiment for a ring core inductor in which the terminal carriers 4a, 4b, 4c are arranged as a fixed component of a core tray (housing of the core) on the ring core K, e.g. at an angular spacing of 120°. The windings are also not shown in this example for clarity.

FIG. 21 shows a side view of an embodiment of the terminal element 5a of FIG. 14. In this example, the wire is guided curved downwards, resulting in an angle α of the wire relative to the SMD connection surface and a cambered shape of the wire end 20. This achieves a defined capillary force when melting the solder in the reflow process, which is an advantage for wetting.

FIG. 22 shows an example (top view) of a choke mounted upright on a printed circuit board with three windings and SMD terminals. The basic construction of the choke is similar to the example in FIG. 12, where the wire ends of the windings 2a-c are led downwards and connected to terminal carriers 4a-c, which are part of a base plate 15, as explained above. The three connection carriers are distributed on the base plate 15 in such a way that an optimized stability is achieved by maximum spacing from each other.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although various embodiments have been illustrated and described with respect to one or more specific implementations, alterations and/or modifications may be made to the illustrated examples without departing from the spirit and scope of the appended claims. With particular regard to the various functions performed by the above described components or structures (units, assemblies, devices, circuits, systems, etc.), the terms (including a reference to a “means”) used to describe such components are intended to correspond—unless otherwise indicated—to any component or structure that performs the specified function of the described component (e.g., that is functionally equivalent), even if it is not structurally equivalent to the disclosed structure that performs the function in the herein illustrated exemplary implementations of the invention.

It will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1-26. (canceled)

27. An inductive component, comprising:
a ring-shaped magnetic core;
at least two windings wound around the ring-shaped magnetic core; and
a plurality of contact feet having openings for insertion of wire ends of the windings,
wherein the contact feet each have a contact surface for surface mounting of the inductive component and the contact surfaces lie in a terminal surface with defined flatness,
wherein the openings in the contact feet are spaced from the terminal surface and are configured such that position and angular deviations of the wire ends with respect to the terminal surface are compensated by the respective contact feet,
wherein each contact foot is materially connected to the wire end inserted into the opening of the respective contact foot.

28. The inductive component of claim 27, wherein the contact feet have approximately a shape of a truncated cone with an opening located at a narrower end of the truncated cone, and wherein at a wider end of the truncated cone, a circumferential ridge forms the contact surface of the contact foot.

29. The inductive component of claim 27, wherein the contact feet are shaped such that a portion of each contact foot, in which the corresponding opening is located, is spaced from the terminal surface, and at least one other portion forms the contact surface of the contact foot which is located in the terminal surface.

30. The inductive component of claim 27, wherein the openings of the contact feet have a contour which is adapted to a cross-section of the wire ends.

31. The inductive component of claim 27, wherein at least a part of the contact feet protrudes beyond an outer contour of the inductive component, so that each part of the contact feet that protrude beyond the outer contour of the inductive component is detectable by a camera that is directed at the terminal surface from above.

32. The inductive component of claim 27, wherein the contact feet are made of copper or a copper alloy.

33. The inductive component of claim 27, where the windings are made of an insulated copper wire.

34. The inductive component of claim 27, wherein at least one of the windings comprises a plurality of interconnected wire segments.

35. The inductive component of claim 27, wherein the contact feet have a tin-plating and/or a nickel underlay.

36. The inductive component of claim 27, wherein the contact feet are soldered or welded to the respective wire ends or connected to the respective wire ends by plastic deformation.

37. The inductive component of claim 27, wherein a winding wire of the windings and the wire ends have a conductor cross-section with a size of 0.5 to 20 mm.

38. A method of manufacturing an inductive component, the method comprising:
producing at least two windings around a magnetic core;
placing contact feet, each having a contact surface for surface mounting of the inductive component such that the contact surfaces of the contact feet lie in a terminal surface with defined flatness;
inserting wire ends of the windings into corresponding openings in the contact feet, the openings in the contact feet being spaced apart from the terminal surface and designed such that position and angular deviations of the wire ends with respect to the terminal surface are compensated for by the respective contact feet; and
materially connecting the contact feet with the respective wire ends.

39. The method of claim 38, wherein placing the contact feet comprises:
inserting the contact feet into a carrier to hold the contact feet in a desired defined position; and
removing the carrier after materially connecting the contact feet with the respective wire ends.

40. An inductive component comprising:
a ring-shaped magnetic core;
at least one winding wound around the ring-shaped magnetic core and comprising a winding wire with a round cross-section; and
exactly three terminal carriers with one or more terminal elements,
wherein wire ends of the winding wires are guided to undersides of the corresponding terminal elements,
wherein the undersides of the terminal elements lie in a terminal plane for surface mounting.

41. The inductive component of claim 40, wherein for a surface mounting with a lying ring core, the terminal carriers are evenly distributed on the ring-shaped magnetic core around a circumference of the ring-shaped core.

42. The inductive component of claim 41, wherein the inductive component has three windings and each of the terminal carriers receives two wire ends of one of the windings.

43. The inductive component of claim 41, wherein the inductive component has one or two windings, and wherein the terminal elements not occupied by a wire end of a winding are occupied by an additional wire piece.

44. The inductive component of claim 41, wherein the inductive component has more than three windings, and wherein the terminal carriers each have two or more terminal elements such that all wire ends of the windings are guided to at least one terminal element and form a contact there for surface mounting.

45. The inductive component of claim 40, where the winding wires are made of insulated copper wire and the wire ends are stripped and tinned.

46. The inductive component of claim 40, wherein the terminal elements are arranged at outer ends of the terminal carriers and have grooves in which the wire ends of the winding wires are guided, and wherein the grooves in the terminal elements are designed such that the wires inserted therein protrude laterally and downwardly to form contacts for surface mounting.

47. The inductive component of claim 46, wherein the terminal carriers are made of a plastic.

48. The inductive component of claim 47, wherein the terminal carriers have a support structure made of metal.

49. The inductive component of claim 40, wherein the terminal elements at outer ends of the terminal carriers have a wire guide structure in which the respective wire ends are bent in a U-shape.

50. The inductive component of claim 40, further comprising:
a separator web with three partial webs connected at a center point, the separator web being arranged in a central opening of the ring-shaped magnetic core and separating the windings from one another.

51. The inductive component of claim 50, wherein the terminal carriers and the separator web form an integral component.

52. The inductive component of claim 40, further comprising:
a core tray in which the ring-shaped magnetic core is arranged,
wherein the terminal carriers are attached to the core tray or form an integral component with the core tray.
